(19) United States
(12) Patent Application Publication
(10) Pub. No.: US 2018/0301243 A1
(43) Pub. Date: Oct. 18, 2018

(54) INTEGRATED SYSTEM FOR IDENTIFYING CABLES AND CONNECTED PERIPHERALS

(71) Applicant: BULL SAS, LES CLAYES SOUS BOIS (FR)

(72) Inventors: Pierre-Laurent POMMIER, SAINT-EGREVE (FR); Martin RADANLIEV, GRENOBLE (FR); Julien ROUX, SAINT MARTIN D`HERES (FR)

(21) Appl. No.: 15/762,744

(22) PCT Filed: Sep. 26, 2016
(86) PCT No.: PCT/EP2016/072853

§ 371 Date: Jun. 25, 2018

(30) Foreign Application Priority Data
Sep. 24, 2015 (FR) 1558991

(51) Int. Cl. H01B 7/36; G06K 17/00; G06K 19/07; G06K 19/077

(52) U.S. Cl. CPC H01B 7/368; G06K 19/07773; G06K 19/0723; G06K 17/0029

(57) ABSTRACT

The present invention relates to an integrated system for identifying cables and connected peripherals comprising at least one cable provided with at least one connector, at least one electronic chip associated with a powering to arrangement, the chip including at least one communication module with a terminal, a memory in which data, identification data of the cable, and at least one identifier are stored, said system being characterized in that it includes at least one antenna arranged along the cable and extending over at least one portion of the cable to be identified, said antenna being connected to the chip to allow data communication between said electronic chip and the communication terminal via activation of a management program contained in said chip.

### TECHNICAL FIELD OF THE INVENTION

The present invention concerns the field of cabling allowing the transmission of communication signals between different types of equipment and, more specifically, an integrated system for identifying cables and connected peripherals.

### TECHNOLOGICAL BACKGROUND OF THE INVENTION

At the current time, it is not always easy to identify a cable on account of numerous restrictions e.g. physical access to all or part of the cable, visibility of cable ends and cable pathway. In addition, cable referencing via a deteriorated third-party system (damaged label, inaccessible database or application requiring specific equipment) can make identification operations complex and even impossible.

Another problem concerns the elements connected to each cable end which, for the same reasons as previously, are not always identifiable.

The most frequent solution to these problems is to stick labels/barcodes or other types of adhesive labelling to identify the ends of a cable and the cable itself. Nevertheless, this solution does not allow modification of an identification that has already been given unless the code is removed and a new code generated with the new data.

Another solution is to identify the branching of cables via a tester, but this requires disconnecting the cable. These techniques are often specific to a given type of cable.

A visual identification solution exists whereby a light source is injected into the cables to see where the other end is. However, this type of solution only works over short distances and does not give any information on the elements connected onto the ends, and no information on the cable itself.

Application WO2013164374 teaches the use of a chip integrated in a cable between a first and a second device in a voice communication system. However, this type of solution does not give any information on the cable itself.

A further solution is to use a cable tracer that injects a signal (given frequency) into the cable and a receiver allows auditive detection of the returned signal. Here again, this type of solution comprises numerous disadvantages and is limited to very restricted cable use.

Document CN204178381 U teaches a multi-function cable identification device applied to a cable laying design system. The device comprises an RFID tag (Radio Frequency IDentification) attached to the cable to be identified, a handheld reader-writer of RFID type to read or write identification data of said cable contained in the RFID chip of the tag, and a server communicating via a communication network with the handheld reader-writer to manage cable parameterization information.

However, good parametrization of cable-related information requires good reception, by the tag, of the signal from the handheld reader-writer. The solution proposed in document CN204178381 U has the disadvantage of not taking this issue of signal quality into account.

### SUMMARY OF THE INVENTION

The present invention has as its object to obviate certain drawback of the prior art relating to cable identification.

This goal is achieved with an integrated system for identifying cables and connected peripherals comprising at least one cable provided with at least one connector, at least one electronic chip associated with a powering to arrangement, the chip including at least one communication module with a terminal, a memory in which data, identification data of the cable and at least one identifier are stored, said system being characterized in that it includes at least one antenna arranged along the cable and extending over at least one portion of the cable to be identified, said antenna being connected to the chip to allow communication of data between said electronic chip and the communication terminal via activation of a management program contained in said chip.

According to another feature, the management program of the electronic chip allows:
receiving of identification data (4) of the cable (1) from a programming device (6) at the time of manufacture of the cable (1);
modification of customizable fields (42) from information contained in instructions received from the terminal (5);
sending of read data required by the communication terminal (5);
write authorization after successful comparison of identifiers.

According to another feature, the identification data of the cable to be identified contain at least the characteristics of the cable to be identified and/or the customizable fields.

According to another feature, one of the characteristics of the cable to be identified is at least:
the cable brand;
the cable model;
the cable serial number;
the cable length;
the type of connector on one end of the cable;
the type of connector on the other end of the cable.

According to another feature, one of the customizable fields is at least:
a customizable user field containing the user's name or company's name;
a customizable field containing the name of the equipment connected onto one end;
a customizable field containing the name of the equipment connected onto the other end.

According to another feature:
the characteristics of the cable are written in the memory of the chip together with information actionable by the management program indicating that they have read-only accessibility;
the customizable fields are written in the memory of the chip together with information actionable by the management program indicating that they are read- and write-accessible.

According to another feature, the communication module is an RFID module.

According to another feature, the powering arrangement is carried out by means of the antenna.

According to another feature, the antenna extends over the entire length of the cable.

According to another feature, the communication terminal comprises at least one RFID communication module.

A further objective is to propose a cable allowing the obtaining of a system conforming to the invention.

This objective is achieved with a cable comprising at least one connector, characterized in that it also comprises at least one antenna disposed along the cable and extending over at least one portion of the cable to be identified.

According to another feature, the cable comprises at least one electronic chip associated with a powering arrangement, the chip comprising at least one memory in which identification data of the cable, and at least one identifier are stored, at least one communication module connected to the antenna of said cable to allow communication of data between said electronic chip and a communication terminal via activation of a management program, said management program allowing implementation of at least one of the following actions:
receiving of identification data of the cable;
identifier comparison;
modification of customizable fields;
sending of required read data;
write authorization after successful comparison of identifiers.

According to another feature, the electronic chip is integrated in the cable.

According to another feature, the electronic chip is integrated in at least one of the connectors

According to another feature, the programming device comprises at least one means for writing the identifier of the electronic chip and characteristics of the cable in the memory of said chip, and at least one program allowing:
configuration of the identification data and sending of these data to the electronic chip in association with a write command;
allocation of an identifier to the electronic chip and sending of this identifier to the electronic chip with a write command.

### BRIEF DESCRIPTION OF THE DRAWINGS

Other features and advantages of the present invention will appear more clearly upon reading the following description, given with reference to the appended drawings, in which:

FIG. 1 is a schematic representation of the functioning of the system according to a first embodiment;

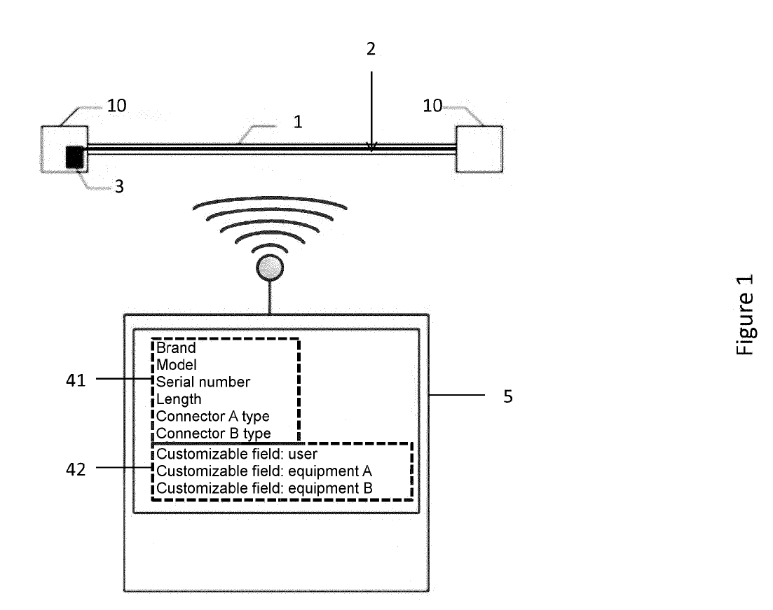

FIG. 2 is a schematic representation of the functioning of the system according to a second embodiment;

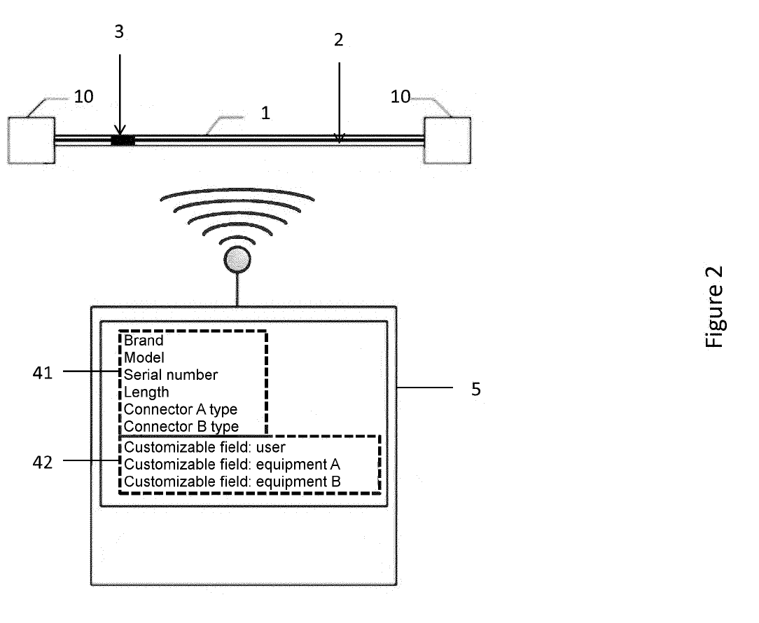

FIG. 3 is a schematic representation of the functioning of the terminal menu according to one embodiment;

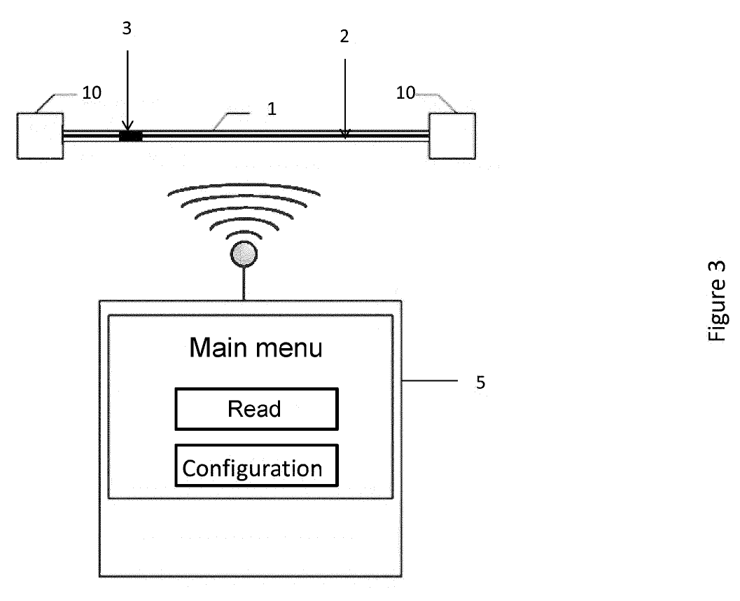

FIG. 4 is a schematic representation of the functioning of the configuration of customizable fields of the electronic chip by the terminal according to one embodiment;

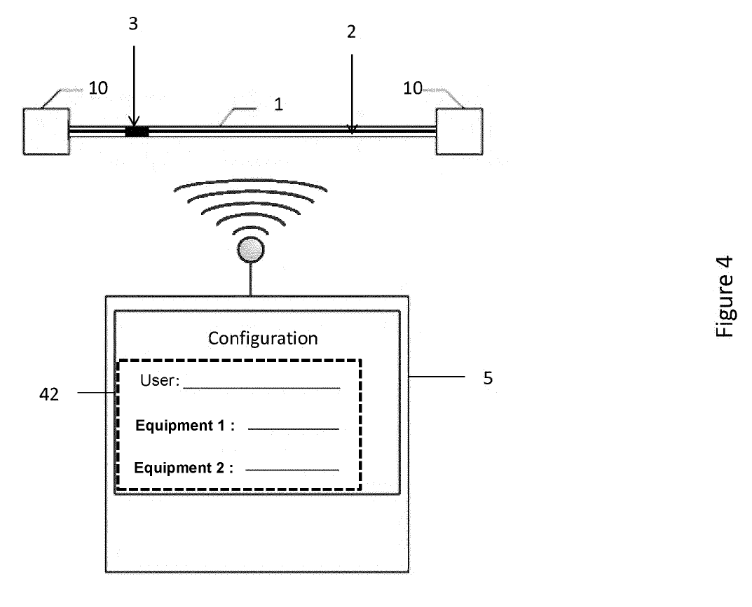

FIG. 5 is a schematic representation of the functioning of data reading by the terminal according to one embodiment;

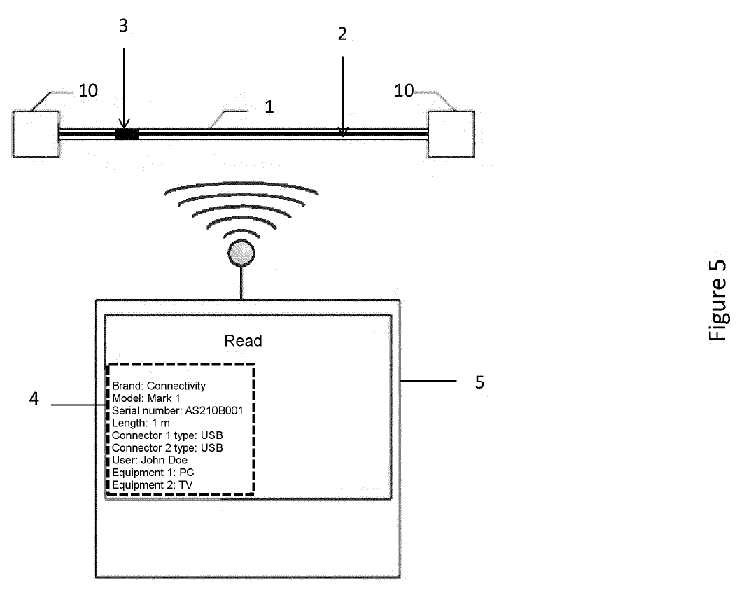

FIG. 6 is schematic representation of the functioning of the initial configuration of the chip by the programming device according to one embodiment.

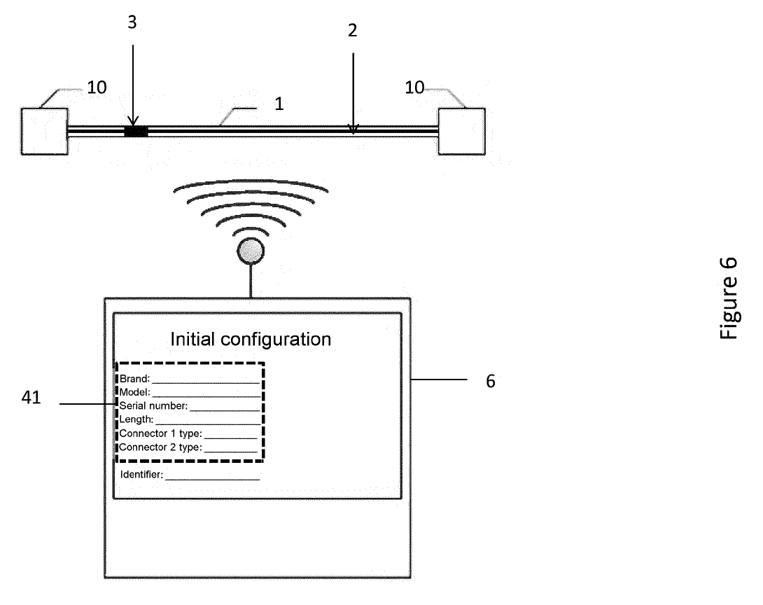

### DETAILED DESCRIPTION

The present invention concerns an integrated system for identifying cables and connected peripherals.

In some embodiments, the integrated system for identifying cables and connected peripherals comprises at least one cable (1) provided with at least one connector (10), at least one electronic chip (3) associated with a powering arrangement, the chip (3) including at least one communication module with a terminal (5), at least one memory in which data, identification data (4) of the cable (1) and at least one identifier are stored, said system being characterized in that it includes at least one antenna (2) arranged along the cable (1) and extending over at least one portion of the cable (1) to be identified, said antenna (2) being connected to the chip (3) to allow communication of data between said electronic chip (3) and the communication terminal (5) via activation of a management program contained in said chip (3).

With this solution it is further possible to meet the issue of signal quality. Indeed, good reception by the electronic chip (3) of the signal from the communication terminal (5) is generally dependent on the surface scanned by said signal transmitted by said communication terminal (5). The use of an antenna disposed along the cable, in particular over at least one portion thereof, e.g. along a pathway parallel to or wound around the cable, allows the reception capacity of the chip to be extended. Advantage is therefore drawn from the fact that the electronic chip (3) equips a cable the length of which is advantageously used to extend the antenna with which the electronic chip is connected, without weakening the assembly. The presence of an antenna (2) arranged along the cable (1) first allows ensured good reception of data by the electronic chip when a signal is transmitted by the communication terminal (5) in the direction of said electronic chip (3), and secondly allows ensured reception of data or reading thereof irrespective of the position of the chip on the cable. For example, and without limitation, if an operator in charge of managing a network of cables must identify a cable by means of the communication terminal, there is no need to position the latter exactly at the position of the electronic chip. It is sufficient for the operator to position the communication cable (5) in the direction of a region of the cable (1) where at least one portion of the antenna (2) is contained. This approach also eases the logistics applied to manage the cable network.

In some embodiments, said antenna (2) extends over the entire length of the cable (1).

In some embodiments, data, called identification data (4) of the cable (1), and at least one identifier are recorded in the memory of the electronic chip (3). Said identification data (4) contain at least the following elements:
the characteristics (41) of the cable to be identified containing at least one of the following elements:
   the cable (1) brand;
   the cable (1) model;
   the cable (1) serial number;
   the cable (1) length;
   the type of connector on one end of the cable (1);
   the type of connector on the other end of the cable (1);
the customizable fields (42) containing at least one of the following elements:
   a customizable user field containing the user's name or company's name;
   a customizable field containing the name of the equipment connected on one end;
   a customizable field containing the name of the equipment connected on the other end.

The characteristics (41) of the cable to be identified are written in the memory of the electronic chip (3) together with information, actionable by the management program of said chip, indicating that they have read-only accessibility. For the customizable fields (42), these are written in the memory of the electronic chip (3) together with information, also actionable by the management program of the chip, indicating that they are read- and write-accessible. Said fields (42) can therefore be modified by the user when the communication terminal (5) scans the electronic chip (3). The information actionable by the management program may be of flag type having an “r” (read) value for read-only or “rw” (read-write) value for reading and writing.

In some embodiments, the management program of the electronic chip allows:
the receiving of identification data (4) of the cable (1) from a programming device (6) at the time of manufacture of the cable (1),
modification of the customizable fields (42) from information contained in instructions received from the terminal (5),
the sending of read data required by the communication terminal (5),
write authorization after successful comparison of identifiers.

In some embodiments, the electronic chip (3) preferably comprises at least one RFID (Radio Frequency IDentification) communication module to enable said identification system to be compatible with a communication terminal (5) using RFID technology. The latter uses radio waves for automatic identification of objects for example.

In some embodiments, the electronic chip (3) is integrated in the cable (1).

In some embodiments, the electronic chip (3) is integrated in at least one of the connectors (10).

In some embodiments, the electronic chip (3) is associated with a powering arrangement. In some embodiments, powering is obtained by means of said antenna (2). Power is supplied by the (magnetic or electromagnetic) wave emitted by the interrogator (terminal (5) and antenna (2)) to power the electronic chip (3).

In some embodiments, the communication terminal (5) comprises at least one communication module preferably of NFC (Near Field Communication) or RFID type, connected to an antenna to allow communication of data between said communication terminal (5) and the electronic chip (3). By data communication, we mean, for example and without limitation, any reading or writing of data on said electronic chip (3) by said communication terminal (5).

The communication terminal (5) further comprises a program allowing the performing of at least one of the following actions:
sending an interrogation to the electronic chip (3);
waiting for the response from the electronic chip (3);
receiving the response from the electronic chip (3);
storing in memory the different fields of the received message;
presenting fields for display.

In some embodiments, said program of the communication terminal (5) with the chip (3) allows to configure the customizable fields (42) by sending write commands in the chip (3) of information associated with identification of the fields to be customized.

A user, via the program, is therefore able to read the identification data (4) of the cable (1) contained in the electronic chip (3). The user is also able to configure the customizable fields (42) as soon as the communication terminal (5) is within range of the cable (1) and as soon as the electronic chip (3) has recognized the identifier of the cable (1) as being correct.

10

Said communication terminal (5) includes at least one Human-Machine interface. By the term human-machine interface, we mean any element enabling a human being to dialogue with a computer and in particular, without this list being exhaustive, a keyboard and means—in response to commands entered via the keyboard—allowing displays and optionally selection by means of a mouse or touchpad of elements displayed on the screen. Another example of embodiment is a touchscreen allowing direct selection on the screen of elements touched by a finger or object and optionally with the possibility of displaying a virtual keyboard. A second example of embodiment is the use of a camera recording movements of the user's eye and using this information to highlight the element on which the user's eye is directed and an additional movement of the eye or head or body part or pressing of a key or stroking of an area of the screen validating the selection made. Another example of human-machine interface may be a voice command for displaying elements and then validating the selection of an element. These examples are solely illustrative and nonlimiting in respect of possible solutions for selecting elements and declaring them to the activation and link module so that the latter can carry out its task.

In some embodiments the communication terminal (5) with the chip (3) comprises means, for example and without limitation a virtual keyboard or a real keyboard of a human-machine interface, enabling the user to enter information in association with the field to be customized. Preferably said communication terminal (5) is a smartphone or tablet.

In some embodiments, the programming device (6) of the cable (1) comprises means for writing the characteristics of the cable (1) and the identifier of the chip (3) in the memory of the chip (3).

The programming device (6) is used after placing the electronic chip (3) on the cable (1) to carry out the initial configuration of the chip (3). For example, and without limitation, said programming device (6) installs the management to program on the electronic chip (3).

In some embodiments, the programming device (6) comprises a program allowing:
configuration of the identification data (4) and sending of these data to the electronic chip (3), in association with a write command;
allocation of an identifier to the electronic chip (3) and sending of this identifier to the electronic chip (3) with a write command.

The fabrication of the integrated system for identifying cables and connected peripherals starts by installing the electronic chip (3) and the antenna (2) on the cable (1), then the electronic chip (3) is programmed at the time of initial configuration by a programming device (6) so as to receive the characteristics (41) of the cable (1) and an identifier. To complete fabrication, the user scans the cable (1) with the communication terminal (5) which contains the list of identifiers of the electronic chips associated therewith, waits for the response of the chip (3) to the request for identification given by the communication terminal (5), reads the data recorded on the chip (3) or configures the customizable fields (42).

The present application describes various technical characteristics and advantages with reference to the figures and/or to various embodiments. Persons skilled in the art will appreciate that the technical characteristics of one given embodiment can be combined with characteristics of another embodiment unless otherwise explicitly indicated or it is obvious that these characteristics are incompatible, or unless the combination does not provide a solution to at least one of the technical problems mentioned in the present application. In addition, the technical characteristics described in one given embodiment can be isolated from the other characteristics of this embodiment, unless otherwise explicitly mentioned.

It will be obvious for skilled persons that the present invention allows embodiments in numerous other specific forms without departing from the field of application of the invention as claimed. Therefore, the present embodiments are to be construed as illustrations that can be modified within the field defined by the scope of the appended claims, and the invention is not to be limited to the details given above.

1. An integrated system for identifying cables and connected peripherals comprising at least one cable provided with at least one connector, at least one electronic chip associated with a powering arrangement, the chip including at least one communication module with a terminal, a memory in which data, identification data of the cable, and at least one identifier are recorded, wherein said system includes at least one antenna arranged along the cable and extending over at least one portion of the cable to be identified, said antenna being connected to the chip to allow communication of data between said electronic chip and the communication terminal via activation of a management program contained in said chip.

2. An integrated system for identifying cables and connected peripherals according to claim 1, wherein the management program of the electronic chip allows:
receiving of identification data of the cable from a programming device at the time of manufacture of the cable,
modification modifying of customizable fields from information contained in instructions received from the terminal,
sending of read data required by the communication terminal,
write authorization after successful comparison of identifiers.

3. An integrated system for identifying cables and connected peripherals according to claim 1, wherein the identification data of the cable to be identified contain at least the characteristics of the cable to be identified and/or the customizable fields.

4. The integrated system for identifying cables and connected peripherals according to claim 1, wherein the characteristics of the cable to be identified is at least:
the cable brand;
the cable model;
the cable serial number;
the cable length;
the type of connector on one end of the cable;
the type of connector on the other end of the cable.

5. An integrated system for identifying cables and connected peripherals according to claim 1, wherein the customizable fields is at least:
a customizable user field containing the user's name or company's name;
a customizable field containing the name of the equipment connected onto one end;
a customizable field containing the name of the equipment connected onto the other end.

6. An integrated system for identifying cables and connected peripherals according claim 1, wherein:
the characteristics of the cable are written in the memory of the chip together with information actionable by the management program indicating that they have read-only accessibility;
the customizable fields are written in the memory of the chip together with information actionable by the management program indicating that they are read- and write-accessible.

7. An integrated system for identifying cables and connected peripherals according to claim 1, wherein the communication module of the electronic chip is an RFID module.

8. An integrated system for identifying cables and connected peripherals according to claim 1, wherein the powering arrangement is carried out by means of the antenna.

9. An integrated system for identifying cables and connected peripherals according to claim 1, wherein the antenna extends over the entire length of the cable.

10. An integrated system for identifying cables and connected peripherals according to claim 1, wherein the communication terminal comprises at least one RFID communication module.

11. A cable comprising at least one connector, characterized in that is also comprises at least one antenna disposed along the cable and extending over at least one portion of the cable to be identified.

12. A cable according to claim 11, wherein comprising at least one electronic chip associated with a powering arrangement, the chip comprising at least one memory in which identification data of the cable, and at least one identifier are stored, at least one communication module connected to the antenna of said cable to allow communication of data between said electronic chip and a communication terminal via activation of a management program, said management program allowing implementation of at least one of the following actions:
receiving of identification data of the cable;
identifier comparison;
modification of customizable fields;
sending of required read data;
write authorization after successful comparison of identifiers.

13. A cable according to claim 12, wherein the electronic chip is integrated in the cable.

14. A cable according to claim 12 wherein the electronic chip is integrated in at least one of the connectors.

15. The integrated system for identifying cables and connected peripherals according to claim 2, wherein the programming device comprises at least one means for writing the identifier of the electronic chip and characteristics of the cable in the memory of said chip, and at least one program allowing:
configuration of the identification data and sending of these data to the electronic chip in association with a write command;
allocation of an identifier to the electronic chip and sending of this identifier to the electronic chip with a write command.
